(19) United States
(12) Patent Application Publication
(10) Pub. No.: US 2021/0029794 A1
(43) Pub. Date: Jan. 28, 2021

(54) SYSTEM FOR DIGITALLY CONTROLLED DIRECT DRIVE AC LED LIGHT

(71) Applicant: BAE Systems Controls Inc., Endicott, NY (US)

(72) Inventor: Darrin M. Weiss, Vestal, NY (US)

(73) Assignee: BAE Systems Controls Inc., Endicott, NY (US)

(21) Appl. No.: 16/936,707

(22) Filed: Jul. 23, 2020

Related U.S. Application Data
(60) Provisional application No. 62/877,611, filed on Jul. 23, 2019.

(51) Int. Cl. H05B 45/20; H05B 45/345; H05B 45/44; F21V 23/00

(52) U.S. Cl. CPC H05B 45/20; H05B 45/345; F21W 2106/00; F21V 23/003; H05B 45/44

(57) ABSTRACT

An AC lighting system where the intensity and/or color may be controlled by varying an output current level of a linear current regulator between a first current level and a second current level and/or varying ON times of a plurality of LED stages, respectively. When the current reaches the second current level, the output current level of the linear current regulator may be maintained at the second current level while ON times are varied is provided. Also provided is an AC lighting system where each switch may be selectively operated to provide power to a bootstrap conditioning network during the period of time when the applied voltage is insufficient to turn on the one or more LEDs corresponding to the respective switch when an LED ON time is short, such that power is provided to respective level shifted drive.

### CROSS REFERENCE TO RELATED APPLICATIONS

This application claims the benefit of and priority to U.S. Provisional Application Ser. No. 62/877,611 filed Jul. 23, 2019 the contents of which is incorporated herein by reference.

### FIELD OF THE DISCLOSURE

The disclosure relates generally to driving light emitting diodes (LEDs), more specifically providing current uniformity over a wide dimming range that allows for dimming down to zero current.

### BACKGROUND

There is a continued demand for efficient lighting systems powered directly from alternating current (AC) power mains. LEDs are commonly used as efficient light emitters, and various solutions implementing LEDs in direct drive AC systems are known in the art. However, prior solutions have key limitations when it is desired to drive the LEDs at very low intensity levels. For example, in a full color solution with a wide color gamut, where a very low intensity level of color at a particular wavelength may be required to reach a particular point in the color space. LEDs are commonly grouped (or “binned”) during manufacturing (by testing at a specific forward current) to have similar characteristics, and producers of lighting systems commonly use these groups or bins to ensure an acceptable level of consistency in their products. However, LEDs that have acceptably similar characteristics (luminous intensity, color) at moderate to high current levels may exhibit much wider variation of these characteristics at low current levels. This variation at low current levels may result in unacceptable performance of the lighting system (poor color match, inability to meet target luminance, etc). Thus, there is a need to provides a means of controlling the current (and thereby the luminous intensity) in the LEDs while avoiding the issues of lowering the peak current to the point where the variation in the LEDs light output becomes unacceptable relative to the lighting system's performance requirements.

### SUMMARY

Accordingly, disclosed is an AC lighting system which may comprises a controller, a linear current regulator, a plurality of stages of LEDs, a plurality of switches, a plurality of level shifted drives and a plurality of bootstrap conditioning networks. The controller may be configured to control at least one of light intensity or color within the system. The linear current regulator may have an output current level which is responsive to a control input. The stages may be coupled with one another between a rectified AC source and ground. Each stage may comprise one or more LEDs connected in series. Each switch may be coupled to an anode of at least one of the one or more LEDs in a stage at its drain and a cathode of at least one of the one or more LEDs in the stage at its source, respectively. The plurality of level shifted drives may be configured to control the plurality of switches, respectively. Each bootstrap conditioning network may condition the power supplied to a respective level shifted drive. The controller may provide at least one of a color or intensity control by at least one of varying the output current level of the linear current regulator between a first current level and a second current level or varying ON times of the plurality of stages. When the current reaches the second current level, the output current level of the linear current regulator may be maintained at the second current level while ON times of the plurality of stages are varied.

In an aspect of the disclosure, the second current level may be set to the LED manufacturer's recommended minimum operating current.

In an aspect of the disclosure, the plurality of switches may be field effect transistors (FETs).

In an aspect of the disclosure, the controller may be coupled to the plurality of level shifted drives.

In an aspect of the disclosure, the ON time for the plurality of stages may be rotated for each cycle. The plurality of stages may comprise a first stage, a second stage and a third stage. The rotation may be, for example, that a first cycle an ON time order is the first stage, the second stage and the third stage, in a second cycle an ON time order is the second stage, the third stage and the first stage and in a third cycle, an ON time order is the third stage, the first stage and the second stage.

In an aspect of the disclosure, the length of time each stage is ON in a cycle may be different.

In an aspect of the disclosure, the ON time of the stages may comprise zero to a maximum ON time.

In an aspect of the disclosure, the LEDs and the plurality of stages may be configured for an interior of an aircraft.

Also disclosed is an AC lighting system which may comprises a controller, a linear current regulator, a plurality of stages of LEDs, a plurality of switches, a plurality of level shifted drives and a plurality of bootstrap conditioning networks. The controller may be configured to control at least one of light intensity or color within the system. The linear current regulator may have an output current level which is responsive to a control input. The stages may be coupled with one another between a rectified AC source and ground. Each stage may comprise one or more LEDs connected in series. Each switch may be coupled to an anode of at least one of the one or more LEDs in a stage at its drain and a cathode of at least one of the one or more LEDs in the stage at its source, respectively. The plurality of level shifted drives may be configured to control the plurality of switches, respectively. Each bootstrap conditioning network may condition the power supplied to a respective level shifted drive. Each switch may be selectively operated to provide power to the bootstrap conditioning network during the period of time when the applied voltage is insufficient to turn on the one or more LEDs corresponding to the respective switch when an LED ON time is short.

In an aspect of the disclosure, each bootstrap conditioning network may comprise a zener diode in parallel with a capacitor, and a diode in series therewith. The bootstrap conditioning network may be coupled to a corresponding level shifted drive.

In an aspect of the disclosure, the plurality of switches may be field effect transistors (FETs).

In an aspect of the disclosure, the controller may be coupled to the plurality of level shifted drives.

In an aspect of the disclosure, the LEDs and the plurality of stages may be configured for an interior of an aircraft.

In an aspect of the disclosure, the controller may provide at least one of a color or intensity control by at least one of varying the output current level of the linear current regulator between a first current level and a second current level or varying ON times of the plurality of stages. When the current reaches the second current level, the output current level of the linear current regulator may be maintained at the second current level while ON times of the plurality of stages are varied.

Implementations of the techniques discussed above may include a method or process, a system or apparatus, a kit, or a computer software stored on a computer-accessible medium. The details or one or more implementations are set forth in the accompanying drawings and the description below. Other features will be apparent from the description and drawings, and form the claims.

### BRIEF DESCRIPTION OF THE DRAWINGS

FIG. 1A is a diagram of a digital AC light (DACL) system in accordance with aspects of the disclosure.

FIG. 1B is a diagram illustrating an example of a bootstrap conditioning network in accordance with aspects of the disclosure.

FIG. 2 is a diagram illustrating a “rotation” scheme of LED stages in accordance with aspects of the disclosure.

FIG. 3 are graphs illustrating the system at full brightness in accordance with aspects of the disclosure.

FIG. 4 are graphs illustrating the system at partial dimming in accordance with aspects of the disclosure.

FIG. 5 are graphs illustrating the system at partial dimming in accordance with aspects of the disclosure.

FIG. 6 are graphs illustrating the system at partial dimming and using bootstrap pulses in accordance with aspects of the present disclosure.

FIG. 7 are graphs illustrating the system at full dimming (LED's OFF) using bootstrap pulses in accordance with aspects of the present disclosure.

These and other features will be understood better by reading the following detailed description, taken together with the figures herein described. The accompanying drawings are not intended to be drawn to scale. For purposes of clarity, not every component may be labeled in every drawing.

### DETAILED DESCRIPTION

LEDs provide an energy efficient lighting solution in a variety of industries and applications. For example, LED lighting systems (luminaires) are often used in aircraft interiors because of their efficiency and longevity. However, existing direct drive AC LED lighting systems fail to support dimming down to very low LED current. This is because existing systems rely on voltage drops across the LEDs in order to generate control voltages. In addition, a method to drive the LEDs at a certain minimum peak current (while varying the average current) needs to be provided.

In other aspects, a luminaire including the lighting system may be used for lighting in other vehicles such as buses, boats, trains and cars. For example, the luminaire may be mounted to the overhead storage bins. In other aspects of the disclosure, the luminaire may be installed in a building such as hall lights, theatre lighting or elevator lighting.

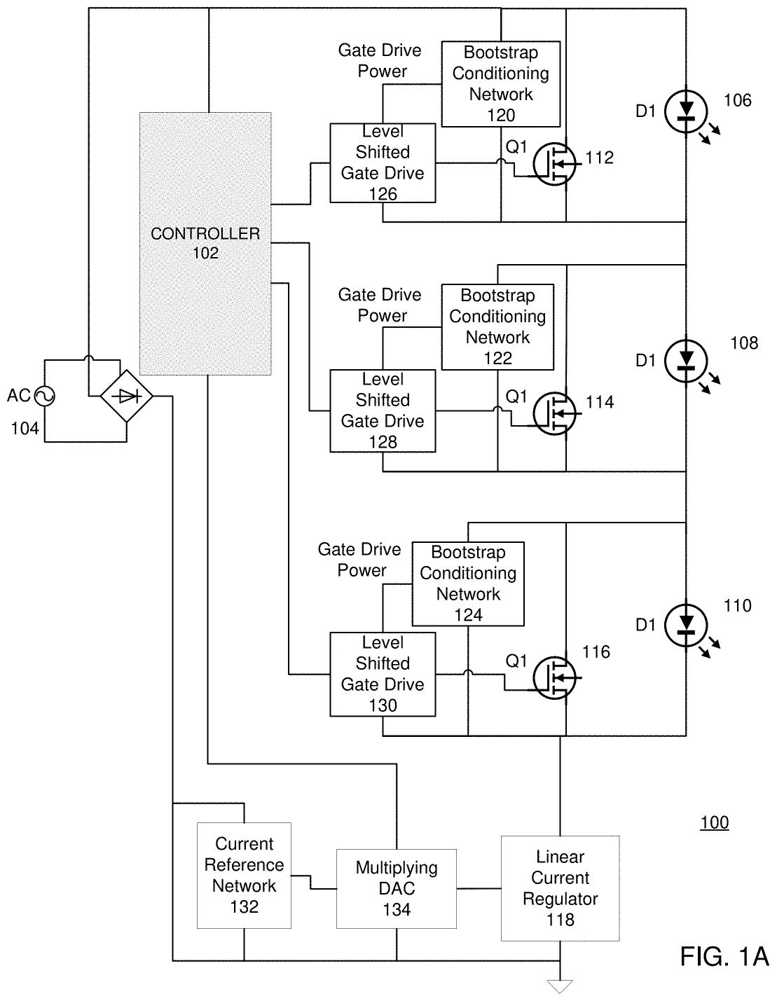

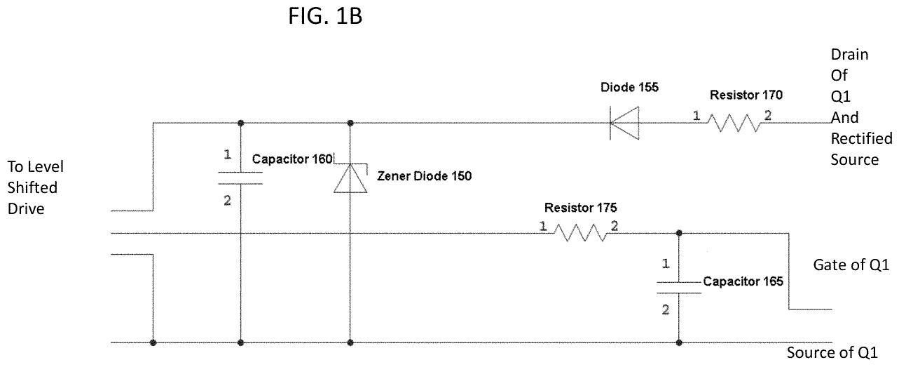

FIG. 1A is a diagram of a digital AC light (DACL) system 100 in accordance with aspects of the disclosure. The system 100 in one example comprises a linear current regulator 118 that has an output current level, which is responsive to a control input. In this case, the linear current regulator 118 is producing a current in phase and proportional in magnitude with the AC line source 104, such that the system is consuming power with very good power quality. There may be a sense resistor in the DACL system 100. The sense resistor may be coupled to ground and the input of the linear current regulator 118.

The system 100 may also comprise a controller 102. The controller 102 may be, but is not limited to, a microcontroller. In other aspects of the disclosure, the controller 102 may be a single or multi-core CPU. In other aspects of the disclosure, the controller 102 may be a field programmable gate array (FPGA).

The controller 102 may be implemented with hardware to execute various functions necessary for the system of the present disclosure. The controller 102 may further comprise control logic, which may be implemented with any combination of software, firmware, and/or hardware. The controller 102 may be coupled to level shifted switch controllers also referred to as level shifted gate drives or drivers 126, 128, 130 in the system 100 of the present disclosure. The controller 102 may provide a control signal to each of the level shifted gate drivers 126, 128, 130, thereby actuating and deactuating each. Level shifted gate drivers need a power source that is also level shifted. Therefore, the power source could be a complex isolated power supply or existing energy in the line of the system 100.

The system 100 may have multiple LEDs 106, 108, 110 (D1). These LEDs 106, 108, 110 may be coupled in series with one another. The LEDs 106, 108, 110 are arranged in stages. FIG. 1A depicts three stages. However, the number of stages is not limited to three stages. FIG. 1A depicts the stages for LEDs of a single color. The system 100 may include multiple colors. For example, in an aspect of the disclosure, there may be red, green, and blue LEDs. In other aspects, white LED(s) could also be used as a fourth color.

Each color may include three stages. The stages for each color may be the same. For example, stage 1 for red, green and blue LEDs may have the same topology. In an aspect of the disclosure, the stages for each color may have the same number of LEDs. However, in other aspects of the disclosure, the stages for different colors may have different number of LEDs. The number of LEDs in different colors may be based on the lighting application. In FIG. 1A, only one LED is shown for each stage. However, the number of LEDs in each stage may be more than one. For example, each stage may have fourteen LEDs. In other aspects, depending on the size of a luminaire, the number of LEDs may be more (or less). For example, the number of LEDs may be based on the application and/or the rectified AC 104.

In an aspect of the disclosure, the system 100 may include a plurality of switches, where each switch may be connected to a different set of LEDs 106, 108, 110. In an aspect of the disclosure the switches may be MOSFETs Q1, such as depicted in FIG. 1A, e.g., 112, 114, 116. However, in other aspects of the disclosure the switches may also be, but not limited to, bipolar junction transistors. Each of the switches 112, 114, 116 may be coupled to an anode of an LED 106, 108, 110 at its drain and a cathode at its source.

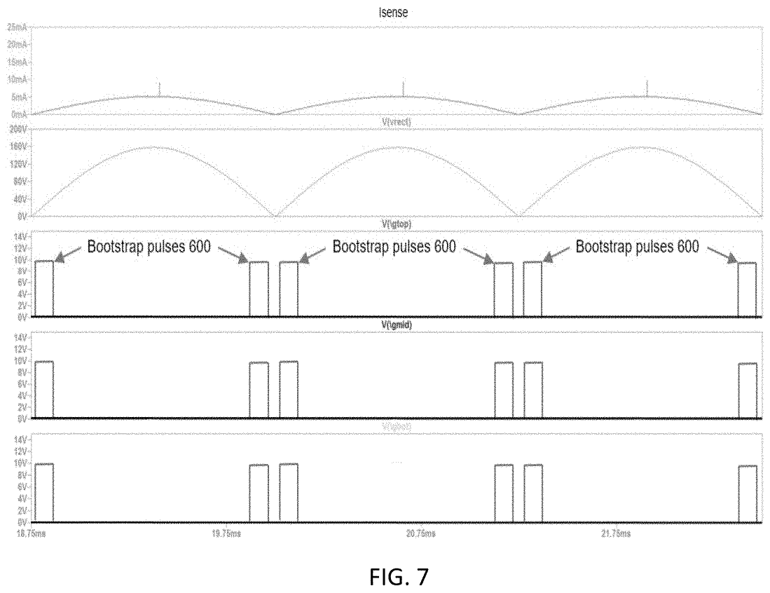

In FIG. 1A, the level shifted gate drivers 126, 128, 130 may be coupled to bootstrap conditioning networks 120, 122, 124. Level shifted voltages of the bootstrap conditioning networks 120, 122, 124 may allow the drivers 126, 128, 130 to properly control each switch. Each switch/gate drive combination may be at a different potential in the circuit, thereby requiring a different supply voltage for operation. In an aspect of the disclosure, when the system 100 is operating with low LED ON time, the bootstrap voltages are generated during the period of time when the line voltage is greater than the bootstrap voltage and less than the LED forward drop. Therefore, the system 100 does not rely on the LED forward conduction time to generate the bootstrap voltages, allowing a dimming range down to zero ON time of the LEDs such as shown in FIG. 7. Additionally, as an added benefit, this configuration may serve to limit the maximum voltage developed across the switch Q1 and drivers 126, 128, 130 if an open LED condition occurs, thereby preventing these components from being exposed to voltages that exceed their ratings.

FIG. 1B is a diagram illustrating an example of a bootstrap conditioning network 120 in accordance with aspects of the disclosure. As depicted, the bootstrap conditioning network 120 is for the top stage in FIG. 1A. The components would be the same for the bootstrap conditioning networks 122, 124 for the other stages, however, the resistor 170 for the other stages would not be directly connected to the AC line source 104 and the drain of switch Q1 but rather to the source of the switch Q1 of a previous stage. The bootstrap conditioning networks 120, 122, 124 may comprise an energy storage element such as a capacitor 160. The capacitor 160 may be connected to two terminals, e.g., pins, of the level shifted gate drive, e.g., 126. For example, the capacitor 160 may be connected to the floating power supply and the return (providing reference). The value of the capacitor 160 is based on the current draw of the level shifted gate drive 126, 128, 130. The bootstrap conditioning network 120, 122, 124 may also comprise a zener diode 150 in parallel with the capacitor 160. The zener diode 150 limits the voltage across the capacitor 160. For example, the zener diode 150 regulates the voltage produced across the gate drive components during the switch OFF time (when the LEDs are ON). The zener diode 150 is selected based on an operating voltage needed for the level shifted gate drive 126, 128, 130. For example, certain level shifted gate drives require 12V for the floating power supply. Other level shifted gate drives require 15V. The bootstrap conditioning network 120, 122, 124 may also comprise a resistor 170 and diode 155. The resistor 170 and diode 155 are connected in series. The resistor 170 limits the current supplied to the bootstrap conditioning network 120, 122, 124. The diode 155 prevents energy stored in the capacitor 160 from being discharged to the LEDs 106, 108, 110, e.g., blocking diode. The diode 155 is selected based on its reverse voltage rating.

When a switch Q1 (e.g., 112) is opened, the capacitor 160 is charged. When the switch Q1 (e.g., 112) is closed, the energy stored in the capacitor 160 is discharged, which provides the power to the level shifted gate drive 126, 128, 130. FIG. 1B also shows resistor 175 and capacitor 165. The resistor 175 is connected between the output of the level shifted gate drive, e.g., 126 (driver) and the gate of the switch Q1 (e.g., 112). The capacitor 165 is connected between the gate and source of the switch Q1 (e.g., 112). The resistor 175 and capacitor 165 may control switching speed to limit sharp switching transients.

The LEDs 106, 108, 110 are powered from an AC line source 104. The AC line source 104 is rectified by a rectifier. The rectified AC may be supplied to a digital-to-analog converter (DAC) 134 (multiplying DAC) via a resistor network 132. The DAC 134 may be a 12 bit D/A. The resistor network 132 may be a resistor divider network in order to provide a scaled AC line source as reference. For example, one or more resistors may be connected to a reference pin (terminal) for the DAC 134. Resistors may also be connected to the control terminals (pins) for the DAC 134. The controller 102 may apply the control signals to the DAC 134 such that the reference is scaled, e.g., multiplied, and applied to the linear current regulator 118. For example, the scaled output of the DAC 134 may be supplied to a terminal of an operational amplifier in the linear current regulator 118.

When the lighting system 100 includes multiple colors, there would be similar stages, DAC 134 and linear current regulator 118 for each color. In an aspect of the disclosure, the same controller 102 may be used to control the LEDs 106, 108, 110 from different colors.

Intensity may also be controlled via the switches Q1 112, 114, 116 (ON time of the LEDs). In an aspect of the disclosure, the controller 102 also controls the switches Q1 112, 114, 116. In an aspect of the disclosure, the timing which each stage is ON may be rotated. The “rotation” of the stages, allows for uniformity along the LEDs stages. A cycle used herein refers to one half of the AC line cycle since the rectification process produces cycles at twice the line frequency. A stage's ON time for a cycle may be changed such that the average current for the stages is the same over time. This creates an impression to the human eye that there is uniform brightness in the stages.

LEDs require a certain amount of voltage to turn them on and illuminate. Thus, and in accordance with an aspect of the disclosure, the controller 102 may cause the first stage of LEDs L1 to be turn ON, e.g., switch Q1 112 opened. For example, the controller 102 may issue control pulses to the level shifted gate drive 126, 128, 130, respectively. The control pulses may be based on the component used as the level shifted gate drive 126, 128, 130. When there is sufficient voltage to turn ON the second stage of LEDs L2, the controller 102 may cause the second stage L2 to turn ON, e.g., switch Q1 114 opened. When there is sufficient voltage to turn ON the third stage of LEDs L3, the controller 102 may cause the third stage L3 to turn ON, e.g., switch Q1 116 opened.

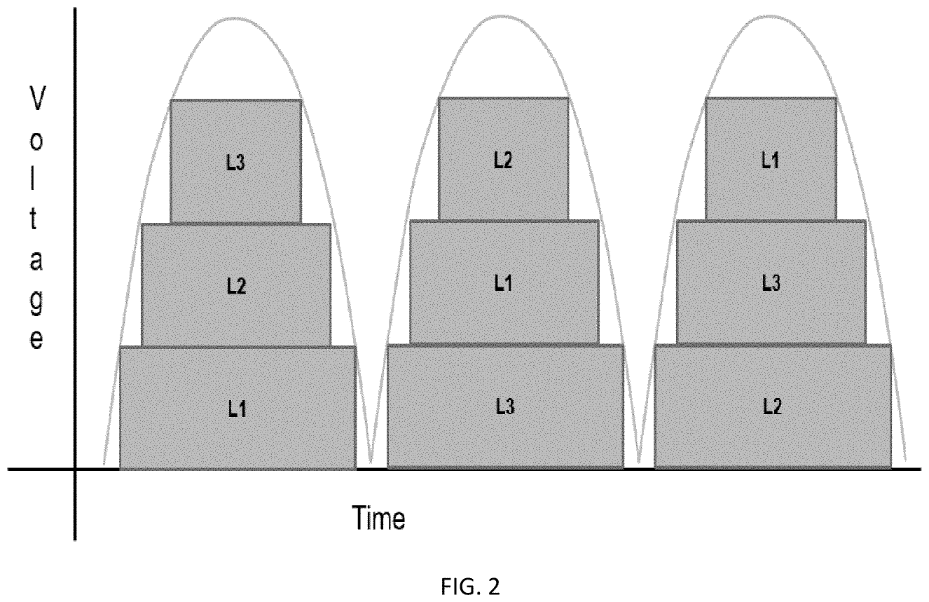

An example of the rotation is shown in FIG. 2. FIG. 2 shows three cycles. In the above described cycle (as shown in FIG. 2 (left), the first stage L1 would be on for the longest period of time relative to the second stage L2 and the third stage L3. The rectangles represent the ON time for each stage. The x-axis is time and the y-axis is voltage. As shown, the first stage L1 is turned ON first (left) and has the widest rectangle. The third stage L3 is turned on last (left) and has the shortest rectangle.

In the example depicted in FIG. 2, the next cycle may start with the controller 102 turning ON the third stage L3 of LEDs (middle). Once there is sufficient voltage, the controller 102 may cause the first stage L1 of LEDs to turn ON. When there is sufficient voltage, the controller 102 may cause the second stage L2 of LEDs to turn ON. In this particular cycle (as shown in FIG. 2 (middle), the third stage L3 would be on for the longest period of time relative to the first stage L1 and the second stage L2.

In the example depicted in FIG. 2, the next cycle (right) may start with the controller 102 causing the second stage L2 of LEDs to turn ON. Once there is sufficient voltage, the controller 102 may cause the third stage L3 of LEDs to turn ON. Once there is sufficient voltage, the controller 102 may cause the first stage L1 of LEDs to turn ON. In this particular cycle, the second stage L2 would be on for the longest period of time relative the third stage L3 and the first stage L1. This leads to each of the LED stage turning off in a certain order as seen in FIG. 2.

The rotation is not limited to the example depicted in FIG. 2 and the order of the cycles and turn ON time may be different. For example, the second cycle may start with the second stage L2. In some aspects of the disclosure, the rotation may be random.

Additionally, this arrangement provides auxiliary control power to the switching elements over a very wide dimming range that includes zero current in the LEDs.

In other aspects of the disclosure, the controller 102 may control the LEDs 106, 108, 110 using a blended approach. For example, the controller 102 may control the current in the LEDs 106, 108, 110 of the system 100 by utilizing a blended approach using both the switches 112, 114, 116 and the linear current regulator 118. In one example, the controller 102 may vary the total current output by the linear current regulator 118 and vary the LED ON time for each cycle.

For example, for the first part of the dimming range, the controller 102 may control the current output by the linear current regulator 118. For a second part of the dimming range, the controller 102 may control the total current in the linear current regulator constant (output by the regulator 118) to be constant, e.g., at a predetermined level and vary the LED ON time within each cycle.

In an aspect of the disclosure, the system 100 may also have a communication interface such as RS485 serial connection to an external controller. For example, when the luminaire having the disclosed system 100 is installed in an aircraft, the system may receive a desired intensity command from cabin control or the flight deck. In other aspects of the disclosure, the luminaire may be directly connected to a dimming control switch. In other aspects of the disclosure, the interface may be a wireless communication interface. For example, the interface may be a Bluetooth interface (BLE) or other near field communication (interface). In other aspects, the interface may include a Zigbee specification low power mesh wireless device, which may operate at a set frequency to eliminate any interface with other networks. For example, when the system 100 in installed in an aircraft, there may be other wireless networks (802.11) such as in-flight entertainment systems.

In an aspect of the disclosure, the controller 102 may compute the desired intensity based on the input received from the interface(s). The current of the linear current regulator 118 and the ON time of the stages may be based on the desired intensity received from the interface(s).

The LEDs 106, 108, 110 may be rated for a certain maximum current. Different types of LEDs may have different maximum current ratings. For example, LEDs have different colors may have different maximum current rating. In an aspect of the disclosure, the maximum current output by the linear current regulator 118 may be based on the maximum current rating for the LEDs 106, 108, 110 in the stages. In some aspects, the maximum current may be determined by derating the maximum current rating for the LEDs 106, 108, 110, e.g., a percentage of the maximum rating. For example, an LED may have a maximum current rating of 30 mA. However, the maximum current output by the linear current regulator 118 may be 20 mA. Since the maximum current rating for different colors may be different, the maximum current output by the linear current regulator 118 for the respective colors, may be different for each color. As noted above, LEDs 106, 108, 110 that have acceptably similar characteristics (luminous intensity, color) at moderate to high current levels may exhibit much wider variation of these characteristics at low current levels. The current levels which the LEDs exhibit the wide variations may vary by manufacturers. Therefore, in an aspect of the disclosure, the minimum current level for the linear current regulator 118 output may be based on the manufacturer of the LEDs. Additionally, LEDs having a different color may also have different minimum current ratings. Therefore, in an aspect of the disclosure, the minimum current level output by the linear current regulator 118 may be different for different colors. In an aspect of the disclosure, the minimum current level may be 5 mA for one color and a different mA for another color.

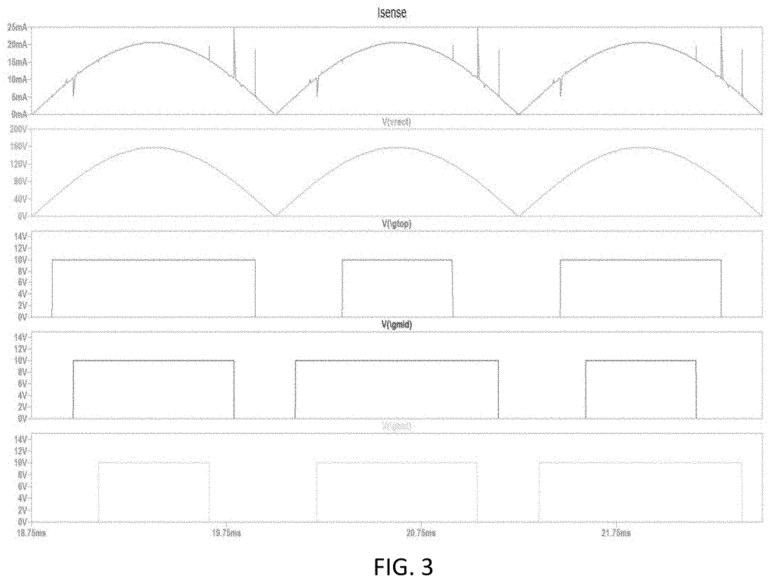

FIGS. 3-6 illustrate examples, of the blended approach showing the waveforms from a simulated LED system in accordance with aspects of the disclosure. The simulated LED system had three stages. Each stage had seven LEDs. The system included MOSFET switches as shown in FIG. 1A and the bootstrap conditioning network as shown in FIG. 1B. The linear current regulator included an operational amplifier and a transistor. A control signal was input into one of the terminals of the operational amplifier. A voltage reference was supplied to the operational amplifier Vs. A sense resistor, as discussed above, was connected to the transistor. A resistor was connected to the base of the transistor and output of the operational amplifier. A capacitor was connected between the base and emitter of the transistor. The emitter/capacitor was connected to the other input terminal of the operational amplifier.

FIG. 3 are graphs illustrating the system at full brightness. In full brightness, the linear current regulator 118 maintains an analog current at the maximum, e.g., 20 mA (using control signals). The level shifted gate drive has a maximum digital ON time determined by the time that the line voltage is above the forward drop of one LED stage. The maximum digital ON time may be determined by the value of the line voltage, the frequency and number of LEDs in a string and number of stages. For example, a 115 VACRMS 400 Hz AC line produces a 800 Hz cycle or 1250 μsec period. The maximum digital ON time for a stage may be about 1043 μsec (where the rectified line voltage >40V, necessary to overcome a 40V drop across the diodes). The maximum digital ON time for another stage may be about 825 μsec (where the rectified line voltage >80V, necessary to overcome a 2*40V drop across the diodes). The maximum digital ON time for another stage may be about 560 μsec (where the rectified line voltage >120V, necessary to overcome a 3*40V drop across the diodes). The maximum on time for any stage may change based on the rotation described herein. The brightness may be dimmed by reducing the ON time. For example, for the same topology and input, the ON time for a stage may be about 520 μsec, ON time for another stage may be 412 μsec and another stage may be about 280 μsec. In accordance with aspects of the disclosure, any variation of ON times of the stage may be provided as long as there is sufficient line voltage to allow the stages to conduct. The rotated ON times may be determine based on a target dimming while factoring in power dissipation in the linear regulator and/or perceived brightness “curve”. In an aspect of the disclosure, the ON times (rotation) may be determined to minimize power dissipation in the linear regulator.

FIG. 3 shows the rectified voltage V(vrect), the current at the sense resistor Isense (which represents the output of the linear current regulator), and the digital ON time for the three stages, V(\gtop), V(\gmid) and V(\gbot). The x-axis is time. For the voltage charts, the y-axis is Volts and for the current chart, the y-axis is current in mA. FIG. 3 shows three cycles.

As shown in FIG. 3, the peak current is 20 mA. FIG. 3 shows the above described rotation.

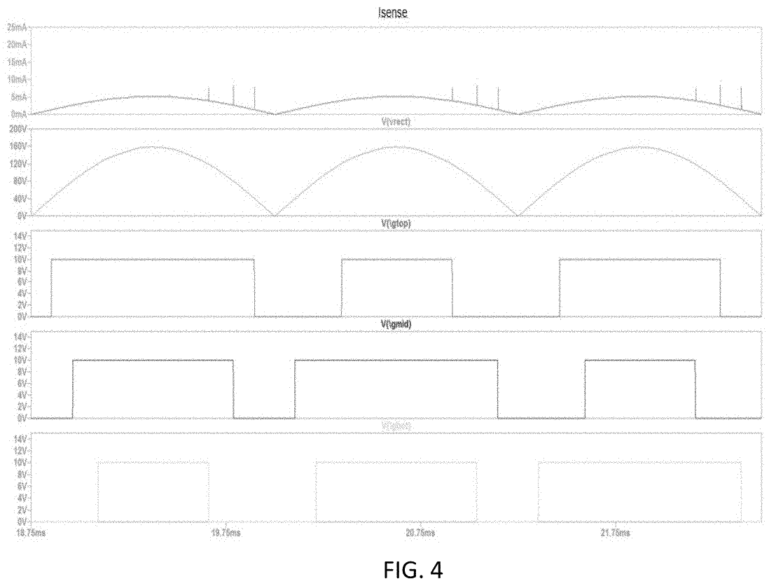

FIG. 4 are graphs illustrating the system at partial dimming in accordance with aspects of the disclosure. In this aspect, the linear current regulator 118 maintains an analog current lower than the maximum. For example, as shown in FIG. 4, the analog current may be at a minimum (predetermined value) with a 5 mA peak. As shown, the digital ON time is the same as in FIG. 3. For example, the digital ON time may be at a maximum. The switching waveforms (square waves) may maintain the same optimum switching times. However, the peak current may be reduced to different values in order to reduce light intensity from FIG. 3.

In an aspect of the disclosure, in the range of 20 mA (maximum, e.g., a first current level) to 5 mA (an example of a second current level), analog dimming may be performed using the current control mechanism described herein (controller 102 controlling the output of the linear current regulator 118 via the DAC 134. In some aspects, the minimum current may be selected as the minimum current at which an LED supplier recommends operating the LEDs 106, 108, 110. The maximum current may also represent a current close to the binning ranges of the LEDs used in the system.

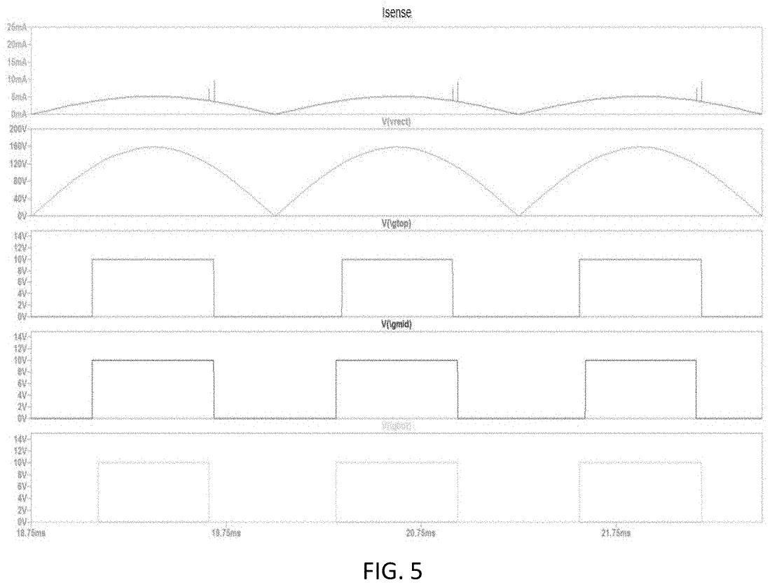

FIG. 5 are graphs illustrating the system at partial dimming in accordance with aspects of the disclosure. In an aspect of the disclosure, the linear current regulator 118 maintains the analog current at a minimum. Additionally, the level shifted gate drive 126, 128, 130 partially reduces the digital ON time. For example, as shown in the top of FIG. 5, the peak current is 5 mA. As shown in FIG. 5, the time in which a stage of LEDs is turn ON during a cycle is delayed with respect to FIGS. 3 and 4. For example, in the first cycle, in FIGS. 3 and 4, the top stage is turned ON first, e.g., V(\gtop). In FIG. 5, the stages are not turned ON until the rectified voltage is higher than in FIGS. 3 and 4. Therefore, in FIG. 5, instead of all three stages being turned ON at different timings, the top stage and the middle stage are turn ON at the same time. This is because the voltage is high enough to turn ON two stages. As depicted in FIG. 5, the bottom stage (V\gbottom) has the same ON time as in FIGS. 3 and 4. The top stage and the middle stage are turned OFF earlier than in FIGS. 3 and 4.

In an aspect of the disclosure, the ON times are still rotated in this dimmed state. For example, in the second cycle, the middle stage and the bottom stage are turned ON together followed by the top stage and in the third cycle, the bottom stage and the top stage are turned ON together followed by the middle stage.

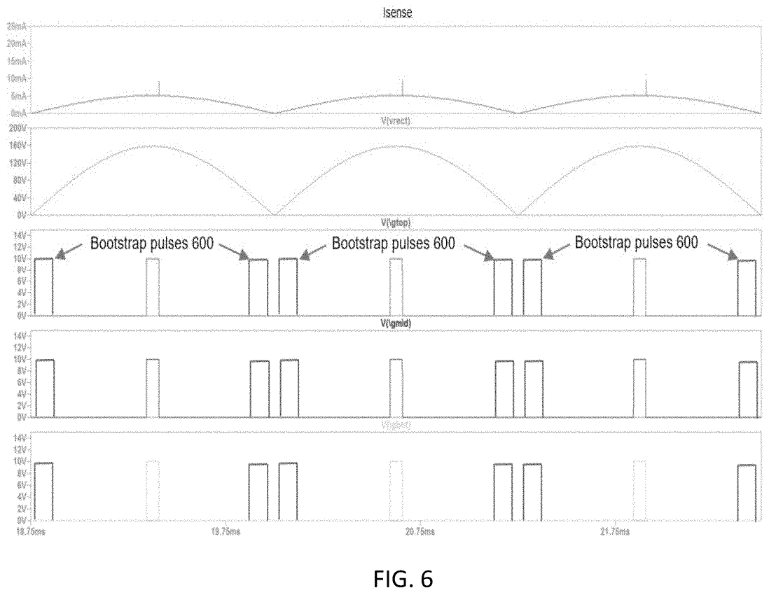

FIG. 6 are graphs illustrating the system at partial dimming in accordance with aspects of the disclosure. A control signal controls the linear current regulator 118 such that the analog current is at a minimum, e.g., 5 mA (predetermined level).

The control signals control the level shifted gate drive 126, 128, 130 such that the digital ON time is significantly reduced.

As shown in FIG. 6, the ON time for each stage is delayed as compared with the ON time for each stage in FIG. 5. Since the ON time is delayed, the rectified voltage is higher when the stages are turned ON. Thus, the rectified voltage is sufficient to turn ON all three stages at the same time (and turn OFF all three stages at the same time). The ON time coincides with the voltage and current peaks. However, the short ON time for LEDs such as shown in FIG. 6 may be insufficient to for the bootstrap conditioning networks 120, 122, 124 to provide power to operate the gate drivers 126, 128, 130 in the system 100.

In accordance with aspects of the disclosure, properly timed bootstrap pulses 600 overcome this insufficiency. For example, the controller 102 may control the switches 112, 114, 116 to open (turned OFF) in order to charge the level shifted gate drivers 126, 128, 130 (e.g., charge the capacitor 160). The controller 102 may control the switches 112, 114, 116 to close (turned ON) before the LEDs turn ON. This is represented by the bootstrap pulses 600 seen in FIG. 6.

In an aspect of the disclosure, there may be two bootstrap pulses 600 per cycle. However, the number of bootstrap pulses 600 is not limited to two. More or less bootstrap pulses 600 may be used depending on the drives 126, 128, 130.

As shown in FIG. 6, the bootstrap pulses 600 are timed to be near the beginning of a rectified AC wave and the end of the rectified AC wave such that the rectified voltage is not high enough to turn ON any stage. For example. as shown in FIG. 6, the first bootstrap pulse 600 in a cycle may be stopped, e.g., switches 112, 114, 116 closed (turned ON), when the rectified voltage is 40V. Similarly, the second bootstrap pulse 600 in a cycle may be started, e.g., switches 112, 114, 116 opened (turned OFF), when the rectified voltage is 40V.

In some aspects of the disclosure, the bootstrap pulses 600 may be symmetric with respect to the rectified AC wave.

FIG. 7 depicts the behavior of dimming down to zero current in the LEDs 106, 108, 110, while still supplying power to the level shifted gate drives 126, 128, 130 via the generation of the bootstrap pulses 600. While FIG. 7 depicts bootstrap pulses 600 in each cycle, in an aspect of the disclosure, the bootstrap pulses 600 may occur on alternate cycles when the LEDs 106, 108, 110 are dimmed down to zero current, e.g. OFF.

In other aspects of the disclosure, instead of waiting until a predetermined current level is reached, e.g., 5 mA, to adjust the stage ON times, the controller 102 may dim the LEDs by controlled both the digital ON times and the analog current level.

As described above, the LEDs may receive power via the rectified AC line 105. However, in other aspects of the disclosure, an AC-AC transformer may be used to increase or reduce the peak line voltage delivered to the luminaire. The use of a transformer may be based on the available input AC power and the application for the luminaire.

The LEDs 106, 108, 110 may be arranged substantially aligned on a LED circuit board. The LED circuit board (and other circuit boards such as a power and/or control board) may be held in a housing. In an aspect of the disclosure, the power may be on the same circuit board. The circuit board(s) may be mounted in the housing via snap in fasteners. The luminaire may also have a diffuser is positioned over the LED circuit board. The diffuser may be held in place via slots in the housing. The diffuser scatters the light emitted from the LEDs 106, 108, 110 in a chosen manner in order to reduce the effect of the light being emitted from LEDs 106, 108, 110 behaving like point sources of light.

In an aspect of the disclosure, the housing may be made of aluminum and formed by extruding.

In an aspect of the disclosure, the luminaire may be modular and connected with other luminaire(s). This may be achieved via end caps with respective opens for connectors. The connectors enable the luminaire to be connected to other luminaire(s) in a daisy chain. The connector being male on the external end and the other being female. The connectors may supply the power (AC line) and control signals from an external controller. For example, when the luminaire is installed in an aircraft, the power may come from the aircraft power, e.g., 115 VAC.

The luminaire may be mounted using mounting brackets.

Various aspects of the present disclosure may be embodied as a program, software, or computer instructions embodied or stored in a computer or machine usable or readable medium, or a group of media which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided, e.g., a computer program product.

The computer readable medium could be a computer readable storage device or a computer readable signal medium. A computer readable storage device, may be, for example, a magnetic, optical, electronic, electromagnetic, infrared, or semiconductor system, apparatus, or device, or any suitable combination of the foregoing; however, the computer readable storage device is not limited to these examples except a computer readable storage device excludes computer readable signal medium. Additional examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer readable storage device is also not limited to these examples. Any tangible medium that can contain, or store, a program for use by or in connection with an instruction execution system, apparatus, or device could be a computer readable storage device.

A computer readable signal medium may include a propagated data signal with computer readable program code embodied therein, such as, but not limited to, in baseband or as part of a carrier wave. A propagated signal may take any of a plurality of forms, including, but not limited to, electro-magnetic, optical, or any suitable combination thereof. A computer readable signal medium may be any computer readable medium (exclusive of computer readable storage device) that can communicate, propagate, or transport a program for use by or in connection with a system, apparatus, or device. Program code embodied on a computer readable signal medium may be transmitted using any appropriate medium, including but not limited to wireless, wired, optical fiber cable, RF, etc., or any suitable combination of the foregoing.

The foregoing description of aspects of the disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

What is claimed is:

1. An AC lighting system, comprising:
a controller configured to control at least one of light intensity or color within the system;
a linear current regulator having an output current level which is responsive to a control input;
a plurality of stages of light emitting diodes (LEDs), the stages are coupled with one another between a rectified AC source and ground, each stage comprises one or more LEDs connected in series;
a plurality of switches, wherein each switch is coupled to an anode of at least one of the one or more LEDs in a stage at its drain and a cathode of at least one of the one or more LEDs in the stage at its source, respective;
a plurality of level shifted drives configured to control the plurality of switches, respectively;
a plurality of bootstrap conditioning networks incorporated within the system used to condition the power supplied to the plurality of level shifted drives, respectively,
wherein the controller provides at least one of a color or intensity control by at least one of varying the output current level of the linear current regulator between a first current level and a second current level or varying ON times of the plurality of stages, wherein when the current reaches the second current level, the output current level of the linear current regulator is maintained at the second current level while ON times of the plurality of stages are varied.

2. The system of claim 1, wherein the second current level is set to the LED manufacturer's recommended minimum operating current.

3. The system of claim 1, wherein the plurality of switches are field effect transistors (FETs).

4. The system of claim 1, wherein the controller is coupled to the plurality of level shifted drives.

5. The system of claim 1, wherein an ON time for the plurality of stages is rotated for each cycle.

6. The system of claim 5, wherein the plurality of stages comprises a first stage, a second stage and a third stage, wherein in a first cycle an ON time order is the first stage, the second stage and the third stage, in a second cycle an ON time order is the second stage, the third stage and the first stage and in a third cycle, an ON time order is the third stage, the first stage and the second stage.

7. The system of claim 6, wherein a length of time each stage is ON in a cycle is different.

8. The system of claim 1, wherein the ON time comprises zero to a maximum ON time.

9. The system of claim 1, wherein the plurality of stages are configured for an interior of an aircraft.

10. An AC lighting system, comprising:
a controller configured to control at least one of light intensity or color within the system;
a linear current regulator having an output current level which is responsive to a control input;
a plurality of stages of light emitting diodes (LEDs), the stages are coupled with one another between a rectified AC source and ground, each stage comprising one or more LEDs connected in series;
a plurality of switches, wherein each switch is coupled to an anode of at least one of the one or more LEDs of a stage at its drain and a cathode of at least one of the one or more LEDs of the stage at its source, respectively;
a plurality of level shifted drives used to control the plurality of switches, respectively;
a plurality of bootstrap conditioning networks incorporated within the system used to condition the power supplied to the plurality of level shifted drives, respectively,
wherein each switch is selectively operated to provide power to the bootstrap conditioning network during the period of time when the applied voltage is insufficient to turn on the one or more LEDs corresponding to the respective switch when an LED ON time is short.

11. The system of claim 10, wherein each bootstrap conditioning network comprises a zener diode in parallel with a capacitor, and a diode in series therewith, the bootstrap conditioning network is coupled to a corresponding level shifted drive.

12. The system of claim 10, wherein the switch of the plurality of switches is a field effect transistor (FET).

13. The system of claim 10, wherein the controller is coupled to the plurality of level shifted drives.

14. The system of claim 10, wherein the plurality of stages are configured for an interior of an aircraft.

15. The system of claim 10, wherein the controller provides at least one of a color or intensity control by at least one of varying the output current level of the linear current regulator between a first current level and a second current level or varying ON times of the plurality of stages, wherein when the output current level reaches the second current level, the output current level of the linear current regulator is maintained at the second current level while ON times of the plurality of stages are varied.
